(19) United States
(12) Patent Application Publication
(10) Pub. No.: US 2018/0088706 A1
(43) Pub. Date: Mar. 29, 2018

(54) MUTUAL CAPACITIVE SENSING ON A MATRIX SENSOR

(71) Applicant: SYNAPTICS INCORPORATED, San Jose, CA (US)

(72) Inventors: Tetsuo TANEMURA, Yokohama (JP); Petr SHEPELEV, Campbell, CA (US)

(21) Appl. No.: 15/611,439

(22) Filed: Jun. 1, 2017

Related U.S. Application Data
(60) Provisional application No. 62/401,750, filed on Sep. 29, 2016.

(51) Int. Cl. G06F 3/044

(52) U.S. Cl. CPC G06F 3/044; G06F 2203/04101

(57) ABSTRACT

An input device and related processing system and method are disclosed for acquiring capacitive measurements. The input device comprises a plurality of sensor electrodes having a repeating arrangement. The plurality of sensor electrodes comprises first sensor electrodes and second sensor electrodes, wherein each first sensor electrode is bordered by a plurality of the second sensor electrodes and forms a respective plurality of sensing nodes with respective ones of the plurality of the second sensor electrodes. The input device further comprises a processing system coupled with the plurality of sensor electrodes. The processing system is configured to sequentially acquire, for each first sensor electrode, a respective plurality of individual measurements, and determine, for each first sensor electrode and using the plurality of individual measurements, a respective plurality of transcapacitive measurements corresponding to the respective plurality of sensing nodes.

### CROSS-REFERENCE TO RELATED APPLICATIONS

This application claims benefit of U.S. provisional patent application Ser. No. 62/401,750, filed Sep. 29, 2016, entitled “MUTUAL CAPACITVE SENSING ON A MATRIX SENSOR”, which is herein incorporated by reference in its entirety.

### BACKGROUND

### Field

Embodiments disclosed herein generally relate to electronic devices, and more specifically, techniques for performing capacitive sensing using sensor electrodes having a repeating arrangement.

### Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

One embodiment described herein is an input device that comprises a plurality of sensor electrodes having a repeating arrangement, the plurality of sensor electrodes comprising first sensor electrodes and second sensor electrodes. Each first sensor electrode is bordered by a plurality of the second sensor electrodes and forms a respective plurality of sensing nodes with respective ones of the plurality of the second sensor electrodes. The input device further comprises a processing system coupled with the plurality of sensor electrodes, the processing system configured to: sequentially acquire, for each first sensor electrode, a respective plurality of individual measurements; and determine, for each first sensor electrode and using the plurality of individual measurements, a respective plurality of transcapacitive measurements corresponding to the respective plurality of sensing nodes.

Another embodiment disclosed herein is a processing system that comprises a sensor module comprising circuitry. The sensor module is configured to couple with a plurality of sensor electrodes, the plurality of sensor electrodes having a repeating arrangement and comprising first sensor electrodes and second sensor electrodes. Each first sensor electrode is bordered by a plurality of the second sensor electrodes and forms a respective plurality of sensing nodes with respective ones of the plurality of the second sensor electrodes. The sensor module is further configured to sequentially acquire, for each first sensor electrode, a respective plurality of individual measurements; and determine, for each first sensor electrode and using the plurality of individual measurements, a respective plurality of transcapacitive measurements corresponding to the respective plurality of sensing nodes.

Another embodiment disclosed herein is a method comprising driving first sensor electrodes of a plurality of sensor electrodes using a first set of signals comprising one or more sensing signals, wherein the plurality of sensor electrodes has a repeating arrangement. The method further comprises acquiring a first plurality of individual measurements using second sensor electrodes of the plurality of sensor electrodes, wherein each second sensor electrode is bordered by a plurality of the first sensor electrodes and forms a respective plurality of sensing nodes with respective ones of the plurality of the first sensor electrodes, wherein the first plurality of individual measurements corresponds to a first sensing node of the respective plurality of sensing nodes. The method further comprises driving the first sensor electrodes using a different, second set of signals comprising one or more sensing signals and acquiring a second plurality of individual measurements using the second sensor electrodes, wherein the second plurality of individual measurements corresponds to a second sensing node of the respective plurality of sensing nodes. The method further comprises determining, using the first plurality of individual measurements and the second plurality of individual measurements, a respective plurality of transcapacitive measurements corresponding to the plurality of sensing nodes.

### BRIEF DESCRIPTION OF DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic block diagram of an input device, according to embodiments described herein.

FIG. 2 illustrates an exemplary sensor electrode arrangement, according to embodiments described herein.

FIGS. 3A and 3B are schematic diagrams illustrating receiver circuitry of an exemplary processing system, according to embodiments described herein.

FIGS. 4A-4F illustrates exemplary sensor electrode arrangements, according to embodiments described herein.

FIG. 5 illustrates a method of capacitive sensing using sensor electrodes having a repeating arrangement, according to embodiments described herein.

FIGS. 6A-6D are diagrams illustrating different periods of a sequence of capacitive sensing using sensor electrodes having a repeating arrangement, according to embodiments described herein.

FIG. 7 is a diagram illustrating a sequence of capacitive sensing using sensor electrodes having a repeating arrangement, according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the disclosure or the application and uses of the disclosure. Furthermore, there is no intention to be bound by any expressed or implied theory presented in the preceding background, summary, or the following detailed description.

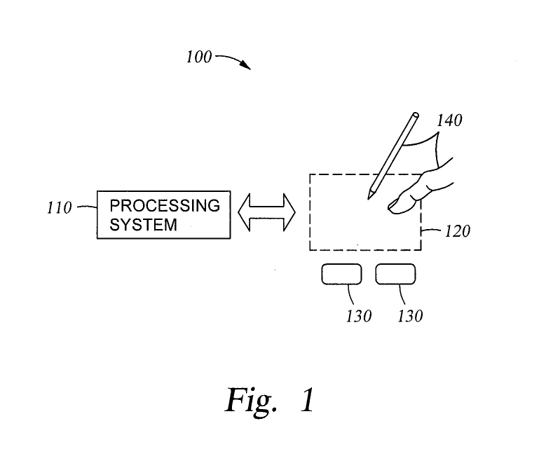

Turning now to the figures, FIG. 1 is a block diagram of an exemplary input device 100, in accordance with embodiments of the disclosure. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects 140 include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self-capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the disclosure are described in the context of a fully functioning apparatus, the mechanisms of the present disclosure are capable of being distributed as a program product (e.g., software) in a variety of forms. For example, the mechanisms of the present disclosure may be implemented and distributed as a software program on information bearing media that are readable by electronic processors (e.g., non-transitory computer-readable and/or recordable/writable information bearing media readable by the processing system 110). Additionally, the embodiments of the present disclosure apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

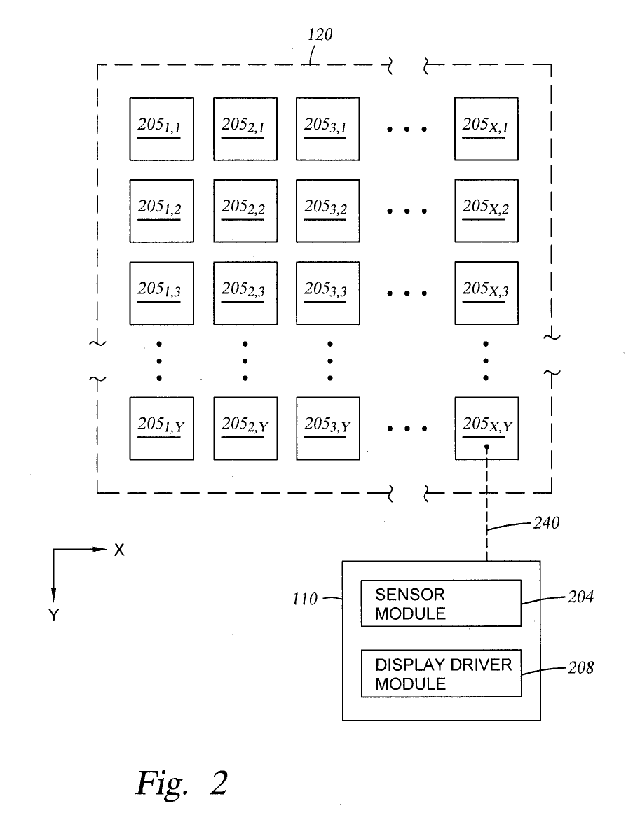

FIG. 2 shows a portion of an exemplary pattern of capacitive sensing pixels 205 (also referred to herein as capacitive pixels or sensing pixels) configured to sense in the sensing region 120 associated with a pattern, according to some embodiments. Each capacitive pixel 205 may include one of more of the sensing elements described above. For clarity of illustration and description, FIG. 2 presents the regions of the capacitive pixels 205 in a pattern of simple rectangles and does not show various other components within the capacitive pixels 205. In one embodiment, the capacitive sensing pixels 205 are areas of localized capacitance (capacitive coupling). Capacitive pixels 205 may be formed between an individual sensor electrode and ground in a first mode of operation and between groups of sensor electrodes used as transmitter and receiver electrodes in a second mode of operation. The capacitive coupling changes with the proximity and motion of input objects in the sensing region 120 associated with the capacitive pixels 205, and thus may be used as an indicator of the presence of the input object in the sensing region 120 of the input device.

The exemplary pattern comprises an array of capacitive sensing pixels 205X,Y (referred collectively as pixels 205) arranged in X columns and Y rows in a common plane, wherein X and Y are positive integers, although one of X and Y may be zero. It is contemplated that the pattern of sensing pixels 205 may comprises a plurality of sensing pixels 205 having other configurations, such as polar arrays, repeating patterns, non-repeating patterns, non-uniform arrays a single row or column, or other suitable arrangement. Further, as will be discussed in more detail below, the sensor electrodes in the sensing pixels 205 may be any shape such as circular, rectangular, diamond, star, square, noncovex, convex, nonconcave concave, etc. As shown here, the sensing pixels 205 are coupled to the processing system 110 and utilized to determine the presence (or lack thereof) of an input object in the sensing region 120.

In a first mode of operation, at least one sensor electrode within the capacitive sensing pixels 205 may be utilized to detect the presence of an input object via absolute sensing techniques. A sensor module 204 in processing system 110 is configured to drive a sensor electrode using a trace 240 in each pixel 205 with a modulated signal (i.e., a capacitive sensing signal) and measure a capacitance between the sensor electrode and the input object (e.g., free space or earth ground) based on the modulated signal, which is utilized by the processing system 110 or other processor to determine the position of the input object.

The various electrodes of capacitive pixels 205 are typically ohmically isolated from the electrodes of other capacitive pixels 205. Additionally, where a pixel 205 includes multiple electrodes, the electrodes may be ohmically isolated from each other. That is, one or more insulators separate the sensor electrodes and prevent them from electrically shorting to each other.

In a second mode of operation, sensor electrodes in the capacitive pixels 205 are utilized to detect the presence of an input object via transcapacitance sensing techniques. That is, processing system 110 may drive at least one sensor electrode in a pixel 205 with a transmitter signal and receive resulting signals using one or more of the other sensor electrodes in the pixel 205, where a resulting signal comprising effects corresponding to the transmitter signal. The resulting signal is utilized by the processing system 110 or other processor to determine the position of the input object.

The input device 100 may be configured to operate in any one of the modes described above. The input device 100 may also be configured to switch between any two or more of the modes described above.

In some embodiments, the capacitive pixels 205 are “scanned” to determine these capacitive couplings. That is, in one embodiment, one or more of the sensor electrodes are driven to transmit transmitter signals. Transmitters may be operated such that one transmitter electrode transmits at one time, or multiple transmitter electrodes transmit at the same time. Where multiple transmitter electrodes transmit simultaneously, the multiple transmitter electrodes may transmit the same transmitter signal and effectively produce an effectively larger transmitter electrode. Alternatively, the multiple transmitter electrodes may transmit different transmitter signals. For example, multiple transmitter electrodes may transmit different transmitter signals according to one or more coding schemes that enable their combined effects on the resulting signals of receiver electrodes to be independently determined.

The sensor electrodes configured as receiver sensor electrodes may be operated singly or multiply to acquire resulting signals. The resulting signals may be used to determine measurements of the capacitive couplings at the capacitive pixels 205.

In other embodiments, “scanning” pixels 205 to determine these capacitive coupling includes driving with a modulated signal and measuring the absolute capacitance of one or more of the sensor electrodes. In another embodiment, the sensor electrodes may be operated such that the modulated signal is driven on a sensor electrode in multiple capacitive pixels 205 at the same time. In such embodiments, an absolute capacitive measurement may be obtained from each of the one or more pixels 205 simultaneously. In one embodiment, the input device 100 simultaneously drives a sensor electrode in a plurality of capacitive pixels 205 and measures an absolute capacitive measurement for each of the pixels 205 in the same sensing cycle. In various embodiments, processing system 110 may configured to selectively drive and receive with a portion of sensor electrodes. For example, the sensor electrodes may be selected based on, but not limited to, an application running on the host processor, a status of the input device, an operating mode of the sensing device and a determined location of an input device.

A set of measurements from the capacitive pixels 205 form a capacitive image (also capacitive frame) representative of the capacitive couplings at the pixels 205 as discussed above. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

In some embodiments, one or more of the sensor electrodes in the capacitive pixels 205 include one or more display electrodes used in updating the display of the display screen. In one or more embodiment, the display electrodes comprise one or more segments of a Vcom electrode (common electrodes), a source drive line, gate line, an anode electrode or cathode electrode, or any other display element. These display electrodes may be disposed on an appropriate display screen substrate. For example, the electrodes may be disposed on the a transparent substrate (a glass substrate, TFT glass, or any other transparent material) in some display screens (e.g., In Plane Switching (IPS) or Plane to Line Switching (PLS) Organic Light Emitting Diode (OLED)), on the bottom of the color filter glass of some display screens (e.g., Patterned Vertical Alignment (PVA) or Multi-domain Vertical Alignment (MVA)), over an emissive layer (OLED), etc. In such embodiments, an electrode that is used as both a sensor and a display electrode can also be referred to as a combination electrode, since it performs multiple functions.

Continuing to refer to FIG. 2, the processing system 110 coupled to the sensing electrodes includes a sensor module 204 and optionally, a display driver module 208. In one embodiment the sensor module comprises circuitry configured to drive a transmitter signal or a modulated signal onto and receive resulting signals with the resulting signals the sensing electrodes during periods in which input sensing is desired. In one embodiment the sensor module 204 includes a transmitter module including circuitry configured to drive a transmitter signal onto the sensing electrodes during periods in which input sensing is desired. The transmitter signal is generally modulated and contains one or more bursts over a period of time allocated for input sensing. The transmitter signal may have an amplitude, frequency and voltage which may be changed to obtain more robust location information of the input object in the sensing region. The modulated signal used in absolute capacitive sensing may be the same or different from the transmitter signal used in transcapacitance sensing. The sensor module 204 may be selectively coupled to one or more of the sensor electrodes in the capacitive pixels 205. For example, the sensor module 204 may be coupled to selected portions of the sensor electrodes and operate in either an absolute or transcapacitance sensing mode. In another example, the sensor module 204 may be coupled to different sensor electrodes when operating in the absolute sensing mode than when operating in the transcapacitance sensing mode.

In various embodiments the sensor module 204 may comprise a receiver module that includes circuitry configured to receive a resulting signal with the sensing electrodes comprising effects corresponding to the transmitter signal during periods in which input sensing is desired. In one or more embodiments, the receiver module is configured to drive a modulated signal onto a first sensor electrode in one of the pixels 205 and receive a resulting signal corresponding to the modulated signal to determine changes in absolute capacitance of the sensor electrode. The receiver module may determine a position of the input object in the sensing region 120 or may provide a signal including information indicative of the resulting signal to another module or processor, for example, a determination module of the processing system 110 or a processor of the electronic device (i.e., a host processor), for determining the position of the input object in the sensing region 120. In one or more embodiments, the receiver module comprises a plurality of receivers, where each receiver may be an analog front ends (AFEs).

In one or more embodiments, capacitive sensing (or input sensing) and display updating may occur during at least partially overlapping periods. For example, as a combination electrode is driven for display updating, the combination electrode may also be driven for capacitive sensing. Or overlapping capacitive sensing and display updating may include modulating the reference voltage(s) of the display device and/or modulating at least one display electrode for a display in a time period that at least partially overlaps with when the sensor electrodes are configured for capacitive sensing. In another embodiment, capacitive sensing and display updating may occur during non-overlapping periods, also referred to as non-display update periods. In various embodiments, the non-display update periods may occur between display line update periods for two display lines of a display frame and may be at least as long in time as the display update period. In such embodiment, the non-display update period may be referred to as a long horizontal blanking period, long h-blanking period or a distributed blanking period. In other embodiments, the non-display update period may comprise horizontal blanking periods and vertical blanking periods. Processing system 110 may be configured to drive sensor electrodes for capacitive sensing during any one or more of or any combination of the different non-display update times.

The display driver module 208 includes circuitry confirmed to provide display image update information to the display of the display device during non-sensing (e.g., display updating) periods. The display driver module 208 may be included with or separate from the sensor module 204. In one embodiment, the processing system comprises a first integrated controller comprising the display driver module 208 and at least a portion of the sensor module 204 (i.e., transmitter module and/or receiver module). In another embodiment, the processing system comprises a first integrated controller comprising the display driver module 208 and a second integrated controller comprising the sensor module 204. In yet another embodiment, the processing system comprises a first integrated controller comprising a display driver module 208 and one of a transmitter module or a receiver module and a second integrated controller comprising the other one of the transmitter module and receiver module.

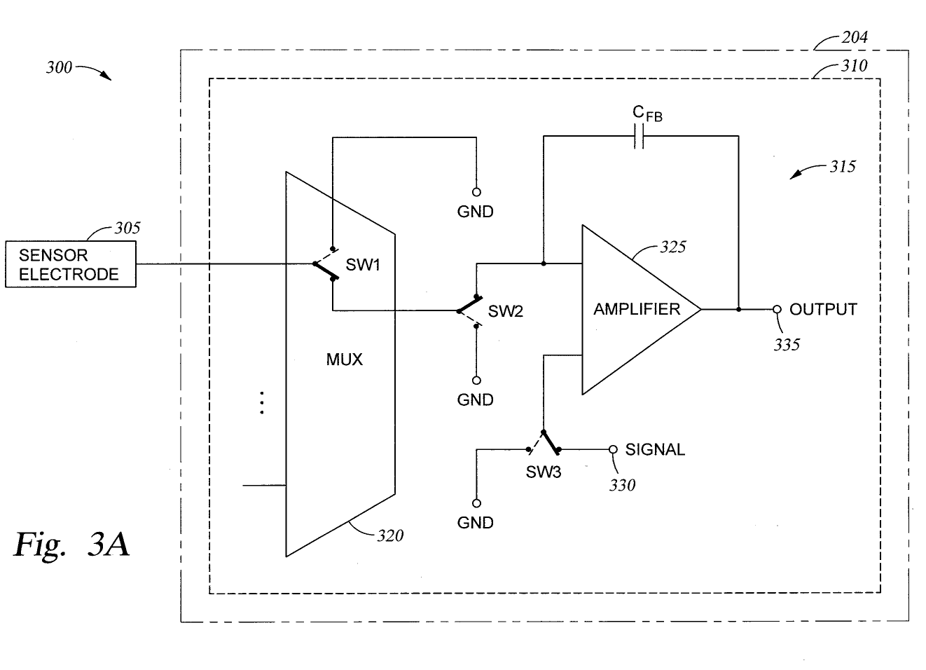

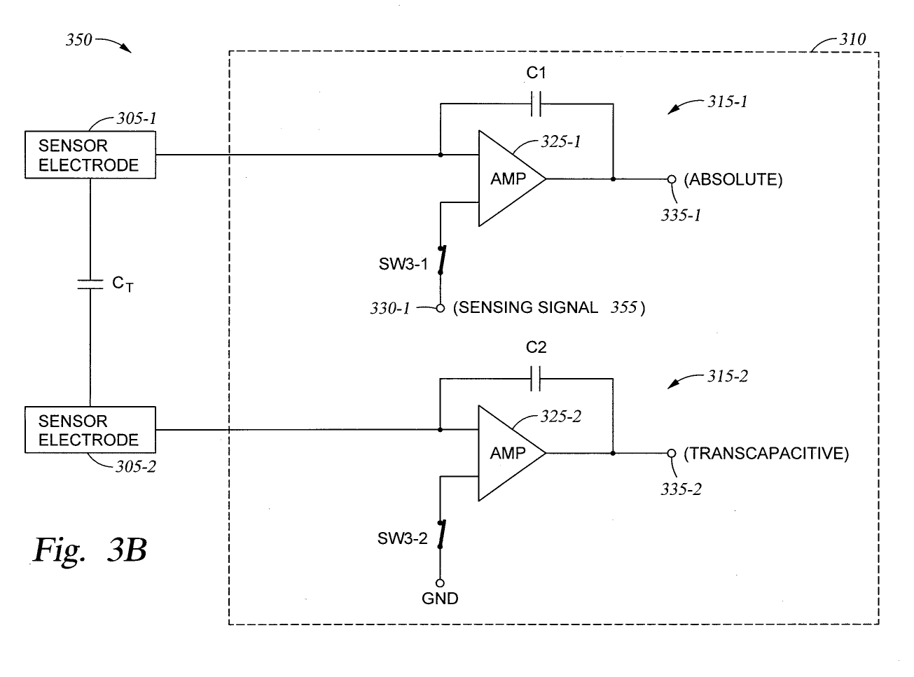

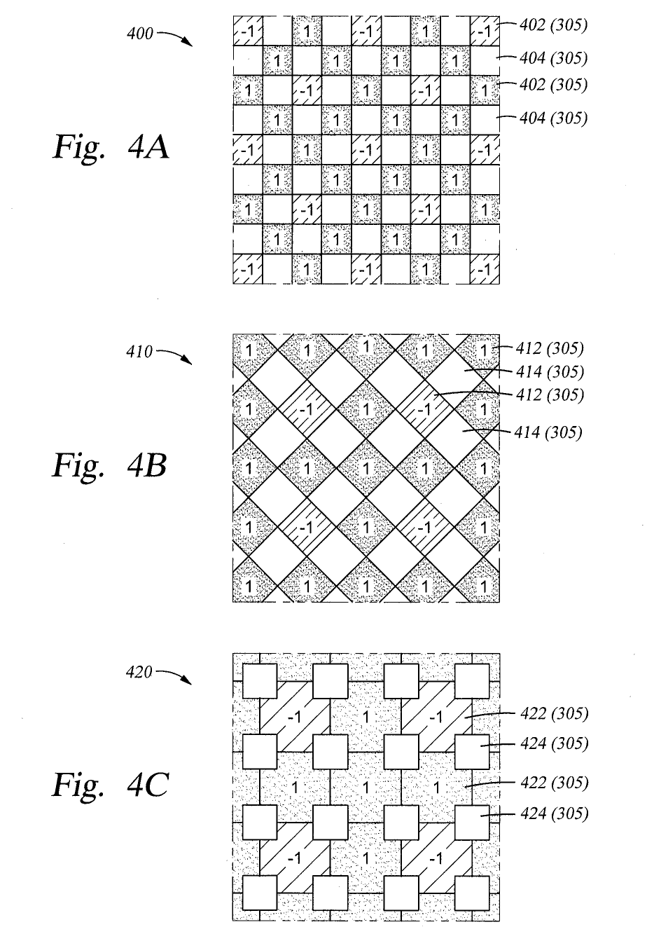

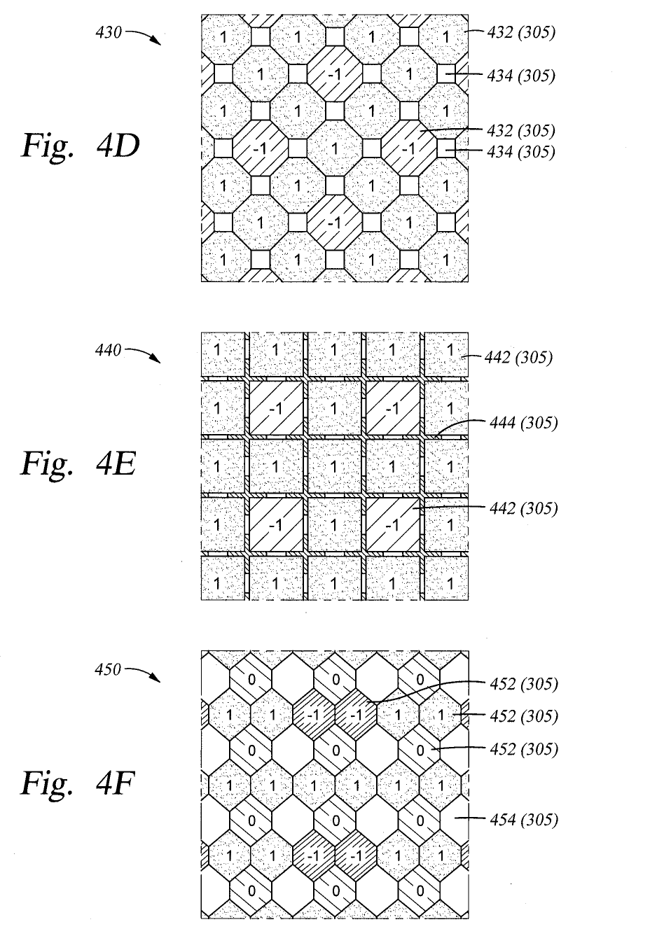

FIGS. 3A and 3B are schematic diagrams illustrating receiver circuitry of an exemplary processing system, according to embodiments described herein. The receiver circuitry may be used in conjunction with other embodiments disclosed herein, such as various sensor electrode arrangements depicted in FIGS. 4A-4F and discussed below.

In diagram 300, a sensor electrode 305 is coupled with receiver circuitry 310 of the sensor module 204. The receiver circuitry 310 comprises an analog front-end (AFE) 315 configured to couple with the sensor electrode 305 and, responsive to driving the sensor electrode 305 with a sensing signal, receive resulting signals for acquiring capacitive measurements. In some embodiments, the sensor electrode 305 is driven with a sensing signal by external circuitry (not shown). In other embodiments, AFE 315 may be configured to both drive the sensing signal onto the sensor electrode 305 and to receive the resulting signals. Although a single sensor electrode 305 and a signal AFE 315 are depicted for simplicity of explanation, the receiver circuitry 310 may comprise a plurality of AFEs 315 that are configured to couple with a plurality of sensor electrodes 305.

The AFE 315 comprises a multiplexer (MUX) 320 and an amplifier 325 coupled with the output of the MUX 320. The MUX 320 is configured to couple with a plurality of sensor electrodes 305 and to connect a selected sensor electrode 305 to the output of the MUX 320. The MUX 320 comprises a switch SW1 that is configured to couple the sensor electrode 305 with a selected one of the output of the MUX 320 and with a ground (GND). In one embodiment, the switch SW1 couples the sensor electrode 305 to the output of the MUX 320 when the sensor electrode 305 is being used for acquiring a capacitive measurement, and couples the sensor electrode 305 to GND when the sensor electrode 305 is not being used for acquiring a capacitive measurement. Although not shown, the MUX 320 may comprise a plurality of switches SW1 corresponding to a plurality of sensor electrodes 305, such that each sensor electrode 305 may be selectively coupled with the output of the MUX 320 and with GND. Further, each switch SW1 may be configured to couple the sensor electrode 305 with one or more other, non-ground reference voltages. For example, the SW1 may be configured to couple the sensor electrode 305 with a guarding signal when the sensor electrode 305 is not being used for a capacitive measurement. The receiver circuitry 310 further comprises a switch SW2 that is coupled with the output of the MUX 320 and an input (e.g., an inverting input) of the amplifier 325. The switch SW2 is configured to couple the input of the amplifier to a selected one of the sensor electrode 305 and to GND or other, non-ground reference voltage(s).

Using a feedback capacitor C_{FB} coupled between the output 335 of the amplifier 325 and the input of the amplifier 325, the AFE 315 is configured to integrate the received resulting signals for acquiring capacitive measurements. The AFE 315 further comprises a switch SW3 coupled with another input (e.g., a non-inverting input) of the amplifier 325. Switch SW3 is configured to couple the input with a selected one of GND and a modulated signal 330. In one embodiment, the switch SW3 couples the amplifier 325 to GND when acquiring transcapacitive measurements between the sensor electrode 305 and neighboring sensor electrodes that are being modulated. The switch SW3 couples the amplifier 325 to the modulated signal 330 when performing absolute capacitive measurements for the sensor electrode 305 relative to nearby conductors including neighboring sensor electrodes and input devices.

Thus, including any of the switches SW1, SW2, and SW3 may be suitable for selectively coupling the sensor electrode 305 with GND or with other, non-ground reference voltage(s). Embodiments of the sensor module 204 may therefore include one or more of the switches SW1, SW2, and SW3. As mentioned above, the use of switch SW3 allows the sensor electrode 305 to be operated as a transmitter electrode and as a receiver electrode. The switches SW1 and SW2 are configured to selectively operate the sensor electrode as a grounded conductor, and may be used where the sensor electrode 305 itself is the subject of sensing (e.g., by other neighboring electrodes), such as during production testing to check for shorting between electrodes, or detecting the presence of an ungrounded conductor (such as a water droplet). An ungrounded conductor, which might otherwise be undetectable, may be coupled with the grounded sensor electrode 305, and therefore may be detected using a neighboring modulated sensor electrode.

The signal 330 may comprise a sensing signal that is also used to drive the sensor electrode 305. In some embodiments, the sensing signal that has a polarity that is selected according to a predefined scheme, such as a predefined code-division multiplexing (CDM) scheme. In other embodiments, the signal 330 applied to the input of the amplifier 325 may be another suitable alternating current (AC) or direct current (DC) reference voltage.

The ability to couple the reference input of each amplifier 325 with different reference voltages enables different types of capacitive sensing (e.g., transcapacitive sensing and absolute capacitive sensing) to be performed by the AFEs 315 of the receiver circuitry 310. In this way, the relative benefits of transcapacitive sensing and of absolute capacitive sensing can be achieved by the receiver circuitry 310 without requiring the different types of capacitive sensing to be performed in distinct periods. Some benefits of transcapacitive sensing may include a lesser number of AFEs of the receiver circuitry 310, the ability to sense over a thin cover lens, and localized noise interference due to a small background capacitance and/or CDM. Some benefits of absolute capacitive sensing include proximity sensing and waking up from a low-power (or “doze”) mode.

Stated another way, the receiver circuitry 310 is configured to acquire transcapacitive measurements and absolute capacitive measurements during the same time period(s). Acquiring the different capacitive measurements within the same time period(s) generally allows greater sensing performance to be achieved within a given sensing time budget, and/or for a given sensing performance level frees some of the sensing time budget to performing other processing. In the case of an integrated display and sensing device, hybrid capacitive sensing can correspond to additional time available for display updating and therefore greater display performance.

In some embodiments, the sensor module 204 is configured to operate in a distinct hybrid sensing mode in which transcapacitive measurements and absolute capacitive measurements are acquired during the same time period(s). The sensor module 204 may be further configured to operate in additional sensing modes, such as a distinct transcapacitive sensing mode and a distinct absolute capacitive sensing mode. Other sensing modes are also possible. The sensor module 204 may select from the sensing modes based on desired and/or actual sensing performance, desired and/or actual display performance, and so forth, and may also dynamically transition between different sensing modes.

FIG. 3B illustrates an example of acquiring absolute capacitive measurements and transcapacitive measurements during a same time period. In diagram 350, a first sensor electrode 305-1 is coupled with a first AFE 315-1, and a second electrode 305-2 is coupled with a second AFE 315-2. The AFE 315-1 comprises an amplifier 325-1 having a feedback capacitor C1 and an output 335-1, and the AFE 315-2 comprises an amplifier 325-2 having a feedback capacitor C2 and an output 335-2. Although a MUX 320 is not explicitly depicted in diagram 350, one or more MUXes 320 may be coupled with the AFE 315-1 and/or the AFE 315-2.

A reference input of the first amplifier 325-1 is coupled through switch SW3-1 to a signal 330-1 and a reference input of the second amplifier 325-2 is coupled through switch SW3-2 to GND. The signal 330-1 may be substantially the same as the sensing signal 355 driven onto the first sensor electrode 305-1. The first sensor electrode 305-1 has a capacitive coupling with the second sensor electrode 305-2, which is depicted as transcapacitance C_{T}. In such a configuration, the AFE 315-1 is configured to acquire an absolute capacitive measurement for the first sensor electrode 305-1 at the output 335-1, and the AFE 315-2 is configured to acquire a transcapacitive measurement corresponding to the transcapacitance C_{T} at the output 335-2. Described another way, the second sensor electrode 305-2 is coupled with an unmodulated AFE 315-2 and is operated as a receiver electrode for acquiring the transcapacitive measurement. The first sensor electrode 305-1 is coupled with a modulated AFE 315-1 and is operated as both a transmitter electrode for the transcapacitive measurement and as a receiver electrode for the absolute capacitive measurement. Further, using the switches SW3-1, SW3-2, the AFEs 315-1, 315-2 may be dynamically reconfigured to acquire transcapacitive measurements and absolute capacitive measurements. Using one or more MUXes 320, the AFEs 315-1, 315-2 may acquire transcapacitive and/or absolute capacitive measurements for different sensor electrode(s) 305 at different times.

FIGS. 4A-4F illustrates exemplary sensor electrode arrangements, according to embodiments described herein. Each of the sensor electrode arrangements has a repeating pattern in which a sensor electrode, when operated as a receiver electrode, is bordered by a plurality of other sensor electrodes and forms a plurality of sensing nodes with respective ones of the plurality of other sensor electrodes. The sensor electrode arrangements may be used in conjunction with other embodiments disclosed herein, such as the sensor module 204 of FIGS. 2 and 3A.

Within the sensor electrode arrangements, sensor electrodes that have a “Tx” designation are operated by the sensor module 204 as transmitter electrodes (i.e., driven with sensing signals) for acquiring a transcapacitive measurement. Sensor electrodes that have a “Rx” designation are operated by the sensor module as receiver electrodes configured to receive resulting signals responsive to driving the sensing signals on the transmitter electrodes. The sensor electrode arrangements may be static, such that one or more individual sensor electrodes may be dedicated receiver electrodes and/or dedicated transmitter electrodes. In other cases, the sensor electrode arrangements may be dynamically reconfigured, such that individual sensor electrodes may be operated as transmitter electrodes during a first period, and as receiver electrodes during a second period.

In some embodiments, the sensor electrodes are arranged in a single layer, such that the sensor electrodes are substantially non-overlapping. In other embodiments, the sensor electrodes are arranged in multiple layers, such that sensor electrodes of different layers may at least partly overlap.

Arrangement 400 of FIG. 4A depicts a rectangular grid of sensor electrodes. Within the arrangement 400, first sensor electrodes 402 are operated as transmitter electrodes Tx (also referred to as first sensor electrodes 402 (Tx)), and second sensor electrodes 404 are operated as receiver electrodes Rx (also referred to as second sensor electrodes 404 (Rx)). As shown, the arrangement 400 has an alternating (or checkerboard) pattern of the first sensor electrodes 402 and the second sensor electrodes 404. Each first sensor electrode 402 and each second sensor electrode 404 is rectangular and may be substantially the same size, although these are not requirements.

In some embodiments, each second sensor electrode 404 (Rx) is bordered by a plurality of first sensor electrodes 402 (Tx). In the rectangular grid of arrangement 400, each second sensor electrode 404 is bordered along each of its four sides by a respective first sensor electrode 402. When operated as a receiver electrode Rx, the second sensor electrode 404 forms a plurality of sensing nodes with respective ones of the plurality of first sensor electrodes 402.

In some embodiments, the sensor module is configured to sequentially acquire, for each second sensor electrode 404, a respective plurality of transcapacitive measurements corresponding to the plurality of sensing nodes. In some embodiments, the sensor module drives the first sensor electrodes 402 (Tx) at a first time using a first set of signals comprising one or more sensing signals. The sensor module acquires a first plurality of transcapacitive measurements using the second sensor electrodes 404 (Rx). At a second time, the sensor module drives the first sensor electrodes 402 (Tx) using a different, second set of signals comprising one or more sensing signals, and acquires a second plurality of transcapacitive measurements using the second sensor electrodes 404. The first set and second set of signals may be determined according to a predefined scheme, such as a predefined CDM scheme. The process may be continued until transcapacitive measurements have been acquired for each of the plurality of sensing nodes formed with the second sensor electrodes 404 (Rx). For example, in arrangement 400, the four sensing nodes that are formed by a particular second sensor electrode 404 may be measured during a sequence of four sensing bursts. The sensor module may be further configured to acquire, responsive to driving the first sensor electrodes 402 (Tx) with sensing signals, absolute capacitive measurements for at least one of the first sensor electrodes 402.

Arrangement 410 of FIG. 4B depicts a grid of diamond-shaped sensor electrodes. Within the arrangement 410, first sensor electrodes 412 are operated as transmitter electrodes Tx (also referred to as first sensor electrodes 412 (Tx)), and second sensor electrodes 414 are operated as receiver electrodes Rx (also referred to as second sensor electrodes 414 (Rx)). As shown, the arrangement 410 has an alternating (or checkerboard) pattern of the first sensor electrodes 412 and the second sensor electrodes 414. Each second sensor electrode 414 is bordered by four first sensor electrodes 412, and the corresponding four sensing nodes may be measured during a sequence of four sensing bursts. Each first sensor electrode 402 and each second sensor electrode 404 is diamond-shaped and may be substantially the same size, although these are not requirements.

Arrangement 420 of FIG. 4C depicts first sensor electrodes 422 that are operated as transmitter electrodes Tx, and second sensor electrodes 424 that are operated as receiver electrodes Rx. In a single layer implementation, the first sensor electrodes 422 each have a plus-sign or cross shape, and the second sensor electrodes 424 each have a rectangular (square) shape. In a multi-layer implementation, the first sensor electrodes 422 may each have a rectangular (square) shape, such that the second sensor electrodes 424 partly overlap one or more of the first sensor electrodes 422. Each second sensor electrode 424 is bordered by four first sensor electrodes 422 and the corresponding four sensing nodes may be measured during a sequence of four sensing bursts.

In some embodiments, each of the second sensor electrodes 424 has a smaller areal extent than each of the first sensor electrodes 422. Beneficially, using receiver electrodes with a smaller areal extent may reduce an amount of background capacitance and generally improve transcapacitive sensing performance of the arrangement 420. In transcapacitive sensing, having a smaller receiver tends to reduce the effects of “low-ground mass”, in which objects that are subject to sensing do not share a common ground with the circuitry of the sensor module 204. While the desired response is a decreased capacitance with the object, the low-ground mass effect results in increased capacitance as the object is seen as floating relative to the receiver electrode. Another benefit of this configuration is that a sensor electrode operated as a transmitter electrode and as a receiver electrode for absolute capacitance measurements may have larger dimensions, which enables the sensor electrode to detect objects at greater distances.

Arrangement 430 of FIG. 4D depicts first sensor electrodes 432 that are operated as transmitter electrodes Tx, and second sensor electrodes 434 that are operated as receiver electrodes Rx. In a single layer implementation, the first sensor electrodes 432 are octagonal, and the second sensor electrodes 434 are rectangular (square). As shown, each of the second sensor electrodes 434 has a smaller areal extent that each of the first sensor electrodes 432. In a multi-layer implementation, the first sensor electrodes 432 may each have a diamond shape, such that the second sensor electrodes 434 partly overlap one or more of the first sensor electrodes 432. Each second sensor electrode 434 is bordered by four first sensor electrodes 432 and the corresponding four sensing nodes may be measured during a sequence of four sensing bursts.

Arrangement 440 of FIG. 4E depicts first sensor electrodes 442 that are operated as transmitter electrodes Tx, and second sensor electrodes 444 that are operated as receiver electrodes Rx. As shown, the first sensor electrodes 442 are substantially rectangular (square), and each of the second sensor electrodes 444 has a plus-sign or cross shape. Each second sensor electrode 444 is bordered by four first sensor electrodes 442 and the corresponding four sensing nodes may be measured during a sequence of four sensing bursts. The second sensor electrodes 444 also have a finer pitch than the first sensor electrodes 442, and each of the second sensor electrodes 444 has a smaller areal extent than each of the first sensor electrodes 442.

Arrangement 450 of FIG. 4F depicts first sensor electrodes 452 that are operated as transmitter electrodes Tx, and second sensor electrodes 454 that are operated as receiver electrodes Rx. As shown, the first sensor electrodes 452 and the second sensor electrodes 454 are hexagonal. Each second sensor electrode 454 is bordered by six first sensor electrodes 452 and the corresponding six sensing nodes may be measured during a sequence of six sensing bursts.

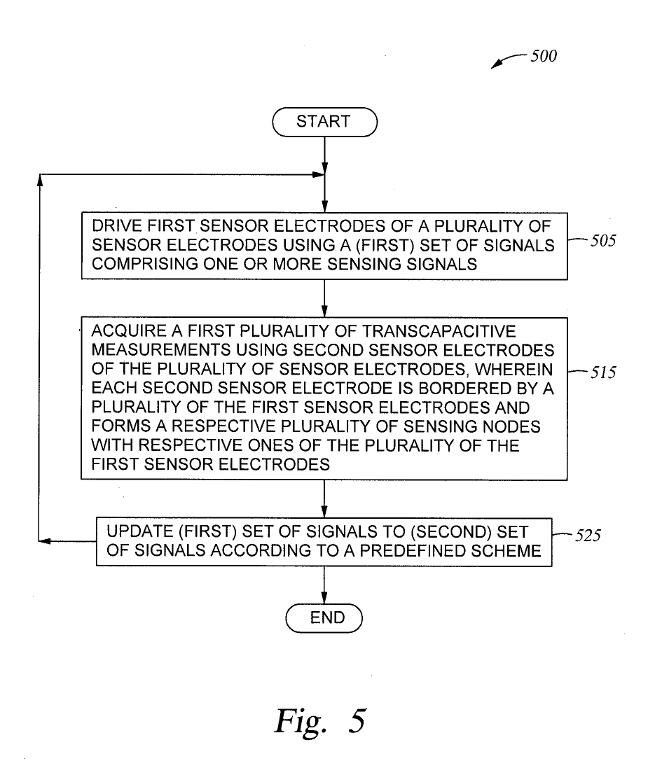

FIG. 5 illustrates a method 500 of capacitive sensing using sensor electrodes having a repeating arrangement, according to embodiments described herein. Method 500 may be performed in conjunction with other embodiments discussed herein, such as the sensor module 204 of FIGS. 2 and 3A and/or the sensor electrode arrangements of FIGS. 4A-4F.

Method 500 begins at block 505, where the sensor module drives first sensor electrodes of a plurality of sensor electrodes using a first set of signals comprising one or more sensing signals. The first set of signals may be determined according to a predefined scheme, such as a CDM scheme. For example, the polarity of the one or more sensing signals may be determined according to the CDM scheme.

At block 515, the sensor module acquires a first plurality of transcapacitive measurements using second sensor electrodes of the plurality of sensor electrodes. Each second sensor electrode is bordered by a plurality of the first sensor electrodes and forms a respective plurality of sensing nodes with respective ones of the plurality of the first sensor electrodes.

In some embodiments, the sensor module may further acquire absolute capacitive sensing measurements using one or more of the first sensor electrodes. In this way, hybrid capacitive sensing may be performed during same time period(s).

At block 525, the sensor module updates the first set of signals to a second set of signals according to the predefined scheme. In some embodiments, updating the first set of signals to the second set of signals comprises changing a polarity of one or more sensing signals included in the first set of signals.

In some embodiments, method 500 returns from block 525 to block 505 to sequentially acquire a plurality of transcapacitive measurements corresponding to the respective plurality of sensing nodes. In some cases, for individual second sensor electrodes, transcapacitive measurements are acquired corresponding to each of the plurality of first sensor electrodes that border the second sensor electrode. Method 500 ends following completion of block 525.

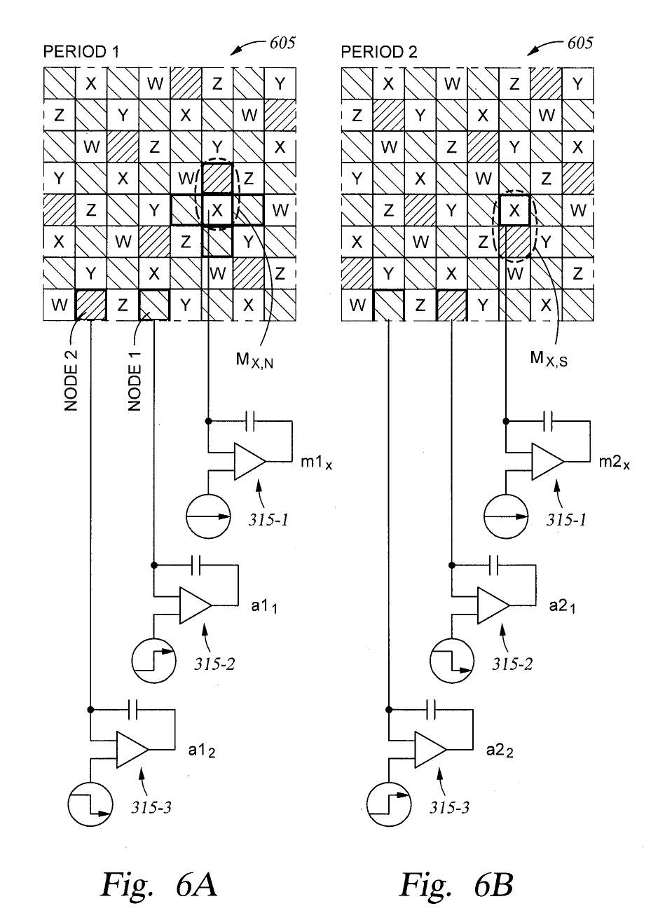

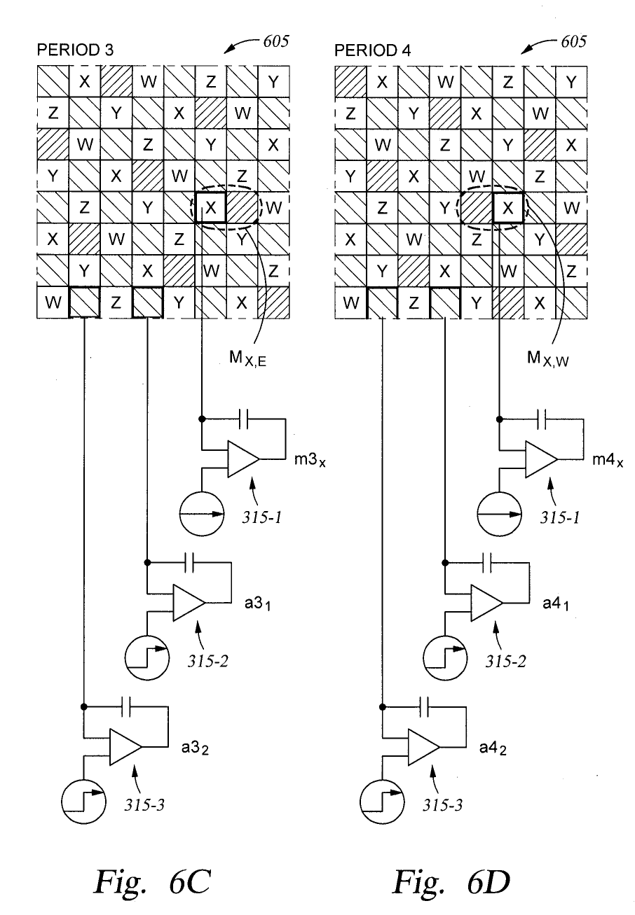

FIGS. 6A through 6D are diagrams illustrating different periods of a sequence 600 of capacitive sensing using sensor electrodes having a repeating arrangement, according to embodiments described herein. The arrangement 605 depicted in sequence 600 generally corresponds to the sensor arrangement 400 of FIG. 4A, and may be used in conjunction with other embodiments discussed herein.

Each of the receiver electrodes in arrangement 605 is designated as one of W, X, Y, and Z types describing the modulation behavior of bordering transmitter electrodes. Described another way, each X-type receiver electrode will have the same pattern of modulation for its bordering transmitter electrodes. As discussed herein, each receiver electrode is bordered by transmitter electrodes to the “north” (or above), “south” (or below), “east” (or to the right), and “west” (or to the left). Thus, each receiver electrode forms a plurality of sensing nodes with the bordering transmitter electrodes. For an X-type receiver electrode, the plurality of sensing nodes are depicted as transcapacitances M_{X,N}, M_{X,S}, M_{X,E}, and M_{X,W}.

As discussed above, the transmitter electrodes may be driven with one or more sensing signals according to a predefined scheme, such as a CDM scheme. As illustrated in the sequence 600, during a first period (Period 1) the transmitter electrode to the north of an X-type receiver electrode is driven with a sensing signal having a negative polarity, e.g., an inverted or phase-shifted copy of a sensing signal. Each period generally corresponds to a sensing burst. The transmitter electrodes to the south, east, and west of the X-type receiver electrode are driven with a sensing signal having a positive polarity. Individual measurements acquired using a first AFE 315-1 (having a GND or DC reference voltage) during the first period are represented as m1ₓ.

During a second period (Period 2) the transmitter electrode to the south of the X-type receiver electrode is driven with the negative-polarity sensing signal, and the transmitter electrodes to the north, east, and west are driven with the positive-polarity sensing signal. Individual measurements acquired using the first AFE 315-1 during the second period are represented as m2ₓ.

During a third period (Period 3) the transmitter electrode to the east of the X-type receiver electrode is driven with the negative-polarity sensing signal, and the transmitter electrodes to the north, south, and west are driven with the positive-polarity sensing signal. Individual measurements acquired using the first AFE 315-1 during the third period are represented as m3ₓ.

During a fourth period (Period 4) the transmitter electrode to the west of the X-type receiver electrode is driven with the negative-polarity sensing signal, and the transmitter electrodes to the north, south, and east, are driven with the positive-polarity sensing signal. Individual measurements acquired using the first AFE 315-1 during the fourth period are represented as m4ₓ.

The operation of the arrangement during Periods 1-4 may be described according to the following operation:

$$[ \begin{matrix}- 1 & 1 & 1 & 1 \\ 1 & - 1 & 1 & 1 \\ 1 & 1 & - 1 & 1 \\ 1 & 1 & 1 & - 1\end{matrix} ] [ \begin{matrix}m {1}_{x} \\ m {2}_{x} \\ m {3}_{x} \\ m {4}_{x}\end{matrix} ] = [ \begin{matrix}{M}_{X , N} \\ {M}_{X , S} \\ {M}_{X , E} \\ {M}_{X , W}\end{matrix} ]$$

where the first matrix represents the values of the different excitation signals that affect the individual measurements m1ₓ, m2ₓ, m3ₓ, m4ₓ. The CDM scheme (or other suitable predefined scheme) is reflected in the first matrix. Here, assuming that the excitation signals differ substantially only in their polarity, the first matrix reflects the polarity of the transmitter electrodes, where (−1) represents a negative polarity and (1) represents a positive polarity. The transcapacitive measurements for each of the sensing nodes (M_{X,N}, M_{X,S}, M_{X,E}, and M_{X,W}) may be determined following completion of the sequence 600.

Thus, a (circulant) deconvolution computation matrix may be applied to the individual measurements m1ₓ, m2ₓ, m3ₓ, and m4ₓ to calculate individual mutual capacitance (or transcapacitance) M for the north, south, east, and west nodes, with respect to the receiver electrodes. For example, M_{X,N}=(−1) m1ₓ+(1) m2ₓ+(1) m3ₓ+(1) m4ₓ.

Other schemes may also be suitable for determining the different transcapacitive measurements M_{X,N}, M_{X,S}, M_{X,E}, and M_{X,W}. In one non-limiting example, the identity matrix may be applied to the individual measurements m1ₓ, m2ₓ, m3ₓ, m4ₓ in the following operation:

$$[ \begin{matrix}1 & 0 & 0 & 0 \\ 0 & 1 & 0 & 0 \\ 0 & 0 & 1 & 0 \\ 0 & 0 & 0 & 1\end{matrix} ] [ \begin{matrix}m {1}_{x} \\ m {2}_{x} \\ m {3}_{x} \\ m {4}_{x}\end{matrix} ] = [ \begin{matrix}{M}_{X , N} \\ {M}_{X , S} \\ {M}_{X , E} \\ {M}_{X , W}\end{matrix} ]$$

where (1) values correspond to driving the sensing signal, and (0) values correspond to not driving the sensing signal (e.g., coupling the corresponding transmitter electrode to GND or other reference voltage). While the CDM scheme discussed above is substantially orthogonal, this is not a requirement so long as the convolution matrix representing the transmitter excitation pattern is invertable.

As discussed above, in some embodiments the sensor module may further acquire absolute capacitive sensing measurements during the same time periods using one or more of the transmitter electrodes. A first transmitter electrode (node1) is coupled with a second AFE 315-2, and a second transmitter electrode (node2) is coupled with a third AFE 315-3.

The first transmitter electrode is driven with a positive-polarity sensing signal during Periods 1, 3, and 4, and with a negative-polarity sensing signal during Period 2. The following operation may be used to determine the absolute capacitance measurement (A_{node1}) for the first transmitter electrode:

$$[ \begin{matrix}1 & - 1 & 1 & 1\end{matrix} ] [ \begin{matrix}a {1}_{1} \\ a {2}_{1} \\ a {3}_{1} \\ a {4}_{1}\end{matrix} ] = {A}_{node 1}$$

where the individual measurements acquired using the second AFE 315-2 during the different time periods are represented as a1₁, a2₁, a3₁, and a4₁.

Similarly, the absolute capacitance measurement (A_{node2}) for the second transmitter electrode may be determined according to the following:

$$[ \begin{matrix}- 1 & 1 & 1 & 1\end{matrix} ] [ \begin{matrix}a {1}_{2} \\ a {2}_{2} \\ a {3}_{2} \\ a {4}_{2}\end{matrix} ] = {A}_{node 2}$$

where the individual measurements acquired using the third AFE 315-3 during the different time periods are represented as a1₂, a2₂, a3₂, and a4₂. The absolute capacitive sensing measurements (e.g., A_{node1}, A_{node2}) may be acquired responsive to driving the sensing signals according to any suitable sensing schemes discussed above, and may be acquired during same time periods as the transcapacitive sensing measurements.

In some embodiments, the length of the sequence is matched to the number of bordering transmitter electrodes to optimize a time budget for scanning the transmitter electrodes (in this example, four). For a next scan burst, the sequence is shifted (or rotated) about the receiver electrode, and the process is repeated corresponding to the length of the sequence (here, four times) until the sequence returns to the original position. As a result, demodulation of these measurements to recover the response on each sensing node is given by a square circulant matrix.

Further, as the bordering transmitter electrodes may be shared by other nearby receiver electrodes, it will be noted that for the response expressed in the matrix equation, the relative physical positions of sensing nodes with respect to the designated receiver electrode types are different such that indexing of each element within the matrix equation should be arranged accordingly.

On a receiver electrode that is coupled to an unmodulated AFE dedicated to mutual capacitive sensing, ‘j’ number of mutual capacitive measurements may be acquired, where is the number of surrounding transmitter electrodes. For ‘k’ number of AFEs, this translates to (j×k) sensing nodes. Advantageously, the values of T and ‘k’ are not constrained by a length and/or width of the sensing surface, and instead may be chosen flexibility. For a sufficient AFE count (i.e., a large ‘k’ value), the value of ‘j’ may be made small so as to minimize the number of scans.

Further, a pad count and/or trace count may be reduced also as much as (j×j+k), when compared with (j×k) of a matrix sensor implementation where (k>>j). On the other hand, if more pads can be afforded for independent routing, each set of sensing nodes may be capacitively decoupled from other sets completely, and “shadow” artifacts may be prevented. This is also because both the receiver electrode and the surrounding transmitter electrodes are equilateral, and it follows that the set of sensing nodes comprising these electrodes together are equilateral and all located under an input object subject to sensing. As a result, no part of these electrodes either lies or is capacitively coupled to other electrodes that are away from the input object (which could cause a shadow artifact). A larger pad count or independent routing for each transmitter electrode also provides flexibility within a sensor module to implement various multiplexing techniques for partial scan and hybrid capacitive sensing. Specifically, each transmitter electrode may also be coupled to an AFE for acquiring absolute capacitive sensing measurements. The AFE for absolute capacitive sensing measurements may be dedicated circuitry (statically connected to the transmitter electrode for simultaneous absolute and mutual capacitive sensing) or may be time multiplexed with that of receiver electrode, which may reduce an AFE count.

Further, dedicated receiver electrodes coupled to an unmodulated AFE for mutual capacitive measurement may be sized, shaped, and pitched differently (usually smaller, skinnier, and finer-pitched) than that of surrounding hybrid electrodes that are operated as both transmitter electrodes and transceiver (i.e., transmitter and receiver) electrodes during mutual and absolute capacitive measurements, respectively.

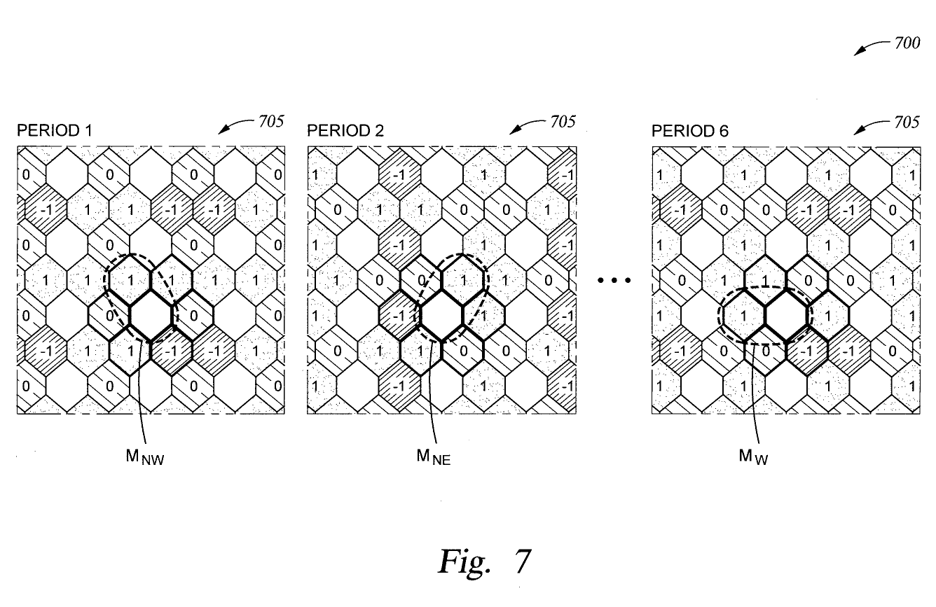

FIG. 7 is a diagram illustrating a sequence 700 of capacitive sensing using sensor electrodes having a repeating arrangement, according to embodiments described herein. The arrangement 705 depicted in sequence 700 generally corresponds to the sensor arrangement 400 of FIG. 4F, and may be used in conjunction with other embodiments discussed herein.

Each of the hexagonal-shaped receiver electrodes in arrangement 705 is bordered by transmitter electrodes to the “northwest” (or above and to the left), “northeast” (or above and to the right), “east” (or to the right), “southeast” (or below and to the right), “southwest” (or below and to the left), and “west” (or to the left). Thus, each receiver electrode forms a plurality of sensing nodes with the bordering transmitter electrodes. For a receiver electrode, the plurality of sensing nodes are depicted as transcapacitances M_{NW}, M_{NE}, M_{E}, M_{SE}, M_{SW}, and M_{W}.

The operation of the arrangement during Periods 1-6 may be described according to the following operation:

$$[ \begin{matrix}1 & 1 & 0 & 1 & - 1 & 0 \\ 0 & 1 & 1 & 0 & 1 & - 1 \\ - 1 & 0 & 1 & 1 & 0 & 1 \\ 1 & - 1 & 0 & 1 & 1 & 0 \\ 0 & 1 & - 1 & 0 & 1 & 1 \\ 1 & 0 & 1 & - 1 & 0 & 1\end{matrix} ] [ \begin{matrix}m 1 \\ m 2 \\ m 3 \\ m 4 \\ m 5 \\ m 6\end{matrix} ] = [ \begin{matrix}{M}_{NW} \\ {M}_{W} \\ {M}_{SW} \\ {M}_{SE} \\ {M}_{E} \\ {M}_{NE}\end{matrix} ]$$

where the first matrix represents the values of the different excitation signals that affect the individual measurements m1, m2, m3, m4, m5, and m6. The CDM scheme (or other suitable predefined scheme) is reflected in the first matrix. Here, assuming that the excitation signals differ substantially only in their polarity, the first matrix reflects the polarity of the transmitter electrodes, where (−1) values represent a negative polarity, (1) values represent a positive polarity, and (0) values represent not driving the sensing signal (e.g., coupling the corresponding transmitter electrode to GND or other reference voltage). The transcapacitive measurements for each of the sensing nodes (M_{NW}, M_{NE}, M_{E}, M_{SE}, M_{SW}, and M_{W}) may be determined following completion of the sequence 700.

Thus, a (circulant) deconvolution computation matrix may be applied to the individual measurements m1-m6 to calculate individual mutual capacitance (or transcapacitance) M for each of the six directions relative to the receiver electrode. For example, M_{NW}=(1) m1+(1) m2+(0) m3+(1) m4+(−1) m5+(0) m6.

As discussed above, in some embodiments the sensor module may further acquire absolute capacitive sensing measurements during the same time periods using one or more of the transmitter electrodes. The following operation may be used to determine the absolute capacitance measurement (A_{node}) for a first transmitter electrode:

$$[ \begin{matrix}- 1 & 1 & 0 & 1 & 1 & 0\end{matrix} ] [ \begin{matrix}a 1 \\ a 2 \\ a 3 \\ a 4 \\ a 5 \\ a 6\end{matrix} ] = {A}_{node}$$

where the individual measurements acquired during the different time periods are represented as a1, a2, a3, a4, a5, and a6.

It should be noted that in the arrangement 705, the sequence for driving surrounding transmitter electrodes with excitation signals varies for different receiver electrodes. For the receiver electrode discussed above, the sequence proceeds in a clockwise direction. For example, the sensor electrode corresponding to m5 is driven with a (−1) value during period 1, the sensor electrode corresponding to m6 is driven with the (−1) value during period 2, and so forth. For the receiver electrodes that share one or more transmitter electrodes with the receiver electrode discussed above, the sequence for driving surrounding transmitter electrodes proceeds in a counterclockwise direction.

Thus, the embodiments and examples set forth herein were presented in order to best explain the embodiments in accordance with the present technology and its particular application and to thereby enable those skilled in the art to make and use the present technology. However, those skilled in the art will recognize that the foregoing description and examples have been presented for the purposes of illustration and example only. The description as set forth is not intended to be exhaustive or to limit the disclosure to the precise form disclosed.

In view of the foregoing, the scope of the present disclosure is determined by the claims that follow.

We claim:

1. An input device comprising:
a plurality of sensor electrodes having a repeating arrangement, the plurality of sensor electrodes comprising:
first sensor electrodes; and
second sensor electrodes, wherein each first sensor electrode is bordered by a plurality of the second sensor electrodes and forms a respective plurality of sensing nodes with respective ones of the plurality of the second sensor electrodes; and
a processing system coupled with the plurality of sensor electrodes, the processing system configured to:
sequentially acquire, for each first sensor electrode, a respective plurality of individual measurements; and
determine, for each first sensor electrode and using the plurality of individual measurements, a respective plurality of transcapacitive measurements corresponding to the respective plurality of sensing nodes.

2. The input device of claim 1, wherein the plurality of sensor electrodes are formed within a single layer of the input device.

3. The input device of claim 1, wherein sequentially acquiring the respective plurality of individual measurements comprises driving the plurality of the second sensor electrodes with sensing signals according to a predefined code-division multiplexing (CDM) scheme.

4. The input device of claim 1, wherein sequentially acquiring the respective plurality of individual measurements comprises driving the plurality of the second sensor electrodes with sensing signals,
wherein the processing system is further configured to:
acquire, responsive to driving the plurality of the second sensor electrodes with sensing signals, absolute capacitive measurements for the plurality of the second sensor electrodes.

5. The input device of claim 1, wherein the first sensor electrodes comprise dedicated transmitter electrodes, wherein the second sensor electrodes comprise dedicated receiver electrodes, and wherein each of the receiver electrodes has a smaller areal extent than each of the transmitter electrodes.

6. The input device of claim 1, wherein the processing system is further configured to acquire absolute capacitive measurements using the first sensor electrodes.

7. The input device of claim 1, wherein the processing system comprises receiver circuitry configured to:
drive the second sensor electrodes with sensing signals, wherein the respective plurality of individual measurements are acquired responsive to driving the second sensor electrodes.

8. A processing system comprising:
a sensor module comprising circuitry, the sensor module configured to:
couple with a plurality of sensor electrodes, the plurality of sensor electrodes having a repeating arrangement and comprising:
first sensor electrodes; and
second sensor electrodes, wherein each first sensor electrode is bordered by a plurality of the second sensor electrodes and forms a respective plurality of sensing nodes with respective ones of the plurality of the second sensor electrodes;
sequentially acquire, for each first sensor electrode, a respective plurality of individual measurements; and
determine, for each first sensor electrode and using the plurality of individual measurements, a respective plurality of transcapacitive measurements corresponding to the respective plurality of sensing nodes.

9. The processing system of claim 8, wherein sequentially acquiring the respective plurality of individual measurements comprises driving the plurality of the second sensor electrodes with sensing signals according to a predefined code-division multiplexing (CDM) scheme.

10. The processing system of claim 8, wherein sequentially acquiring the respective plurality of individual measurements comprises driving the plurality of the second sensor electrodes with sensing signals,
wherein the sensor module is further configured to:
acquire, responsive to driving the plurality of the second sensor electrodes with sensing signals, absolute capacitive measurements for the plurality of the second sensor electrodes.

11. The processing system of claim 8, wherein the circuitry of the sensor module comprises receiver circuitry configured to:
drive the second sensor electrodes with sensing signals, wherein the respective plurality of individual measurements are acquired responsive to driving the second sensor electrodes.

12. The processing system of claim 11, wherein the receiver circuitry comprises a plurality of analog front-ends (AFEs), each AFE of the plurality of AFEs comprising:
an amplifier; and
a switch element configured to selectively couple an input of the amplifier with a sensing signal of the sensing signals.

13. The processing system of claim 12, wherein acquiring a respective plurality of individual measurements comprises:
coupling, using the switch elements of one or more first AFEs of the plurality of AFEs, the second sensor electrodes with the sensing signals; and
coupling, using the switch elements of one or more second AFEs of the plurality of AFEs, the first sensor electrodes with one or more reference signals.

14. The processing system of claim 13, wherein coupling the second sensor electrodes with the sensing signals comprises:
selecting a polarity for individual sensing signals the sensing signals according to a predefined code-division multiplexing (CDM) scheme.

15. A method comprising:
driving first sensor electrodes of a plurality of sensor electrodes using a first set of signals comprising one or more sensing signals, wherein the plurality of sensor electrodes has a repeating arrangement;
acquiring a first plurality of individual measurements using second sensor electrodes of the plurality of sensor electrodes, wherein each second sensor electrode is bordered by a plurality of the first sensor electrodes and forms a respective plurality of sensing nodes with respective ones of the plurality of the first sensor electrodes, wherein the first plurality of individual measurements corresponds to a first sensing node of the respective plurality of sensing nodes;
driving the first sensor electrodes using a different, second set of signals comprising one or more sensing signals;
acquiring a second plurality of individual measurements using the second sensor electrodes, wherein the second plurality of individual measurements corresponds to a second sensing node of the respective plurality of sensing nodes; and
determining, using the first plurality of individual measurements and the second plurality of individual measurements, a respective plurality of transcapacitive measurements corresponding to the plurality of sensing nodes.

16. The method of claim 15, wherein the first set of signals and the second set of signals are determined according to a predefined code-division multiplexing (CDM) scheme.

17. The method of claim 15, further comprising:
acquiring, responsive to driving the first sensor electrodes using the first set of signals, absolute capacitive measurements for at least one of the first sensor electrodes.

18. The method of claim 15, wherein acquiring the first plurality of individual measurements and acquiring the second plurality of individual measurements are performed using receiver circuitry coupled with the plurality of sensor electrodes, and
wherein driving the first sensor electrodes with the first set of signals and driving the first sensor electrodes with the second set of signals is performed using the receiver circuitry.

19. The method of claim 18, wherein the receiver circuitry comprises a plurality of analog front-ends (AFEs), each AFE of the plurality of AFEs comprising:
an amplifier; and
a switch element configured to selectively couple an input of the amplifier with a sensing signal of the one or more sensing signals.

20. The method of claim 19, wherein acquiring a first plurality of transcapacitive measurements comprises:
coupling, using the switch elements of one or more first AFEs of the plurality of AFEs, the first sensor electrodes with the first set of signals; and
coupling, using the switch elements of one or more second AFEs of the plurality of AFEs, the second sensor electrodes with one or more reference signals.
